(19) United States
(12) Patent Application Publication
(10) Pub. No.: US 2013/0194644 A1
(43) Pub. Date: Aug. 1, 2013

(54) IMAGE DISPLAY SYSTEMS

(71) Applicants: Adrian James Cable, San Jose, CA (US); Paul Richard Routley, Cambridgeshire (GB); Euan Christopher Smith, Cambridgeshire (GB)

(72) Inventors: Adrian James Cable, San Jose, CA (US); Paul Richard Routley, Cambridgeshire (GB); Euan Christopher Smith, Cambridgeshire (GB)

(73) Assignee: LIGHT BLUE OPTICS LTD, Cambridgeshire (UK)

(21) Appl. No.: 13/361,895

(22) Filed: Jan. 30, 2012

(30) Foreign Application Priority Data
Jan. 30, 2012 (GB) GB1201495.7

(51) Int. Cl. G03H 1/08; G02B 27/48; G03B 21/14

(52) U.S. Cl. 359/9; 353/84; 362/317; 353/121; 977/774; 977/952

(57) ABSTRACT

We describe a holographic image projector, comprising: a laser light source to provide light at a laser wavelength; a first spatial light modulator (SLM) to display a hologram, wherein said first SLM is illuminated by said laser light source; intermediate image optics to provide a first intermediate real image plane at which a real image produced by said hologram displayed on said first SLM is formed; a wavelength-conversion material located at said first intermediate real image plane to convert said laser wavelength to at least a first output wavelength different to said laser wavelength; and second optics to project light from said real image at said output wavelength to provide a displayed image.

### CROSS-REFERENCE TO RELATED APPLICATIONS

This application claims priority to UK application no. GB1201495.7, filed Jan. 30, 2012. This United Kingdom application is hereby incorporated by reference as though fully set forth herein.

### FIELD OF THE INVENTION

This invention relates to image display systems using a laser light source, more particularly to holographic image projectors.

### BACKGROUND TO THE INVENTION

We have previously described a range of techniques for projecting an image onto a screen using holography, both directly (substantially perpendicularly) and at an acute angle. We have also described techniques for making such displays touch sensitive. Examples of our earlier published patent applications include WO2010/074404 and WO/2010/073024 (hereby incorporated by reference).

Image projection systems such as these, which employ a laser light source, are prone to speckle. It is also difficult to achieve high efficiency operation at some wavelengths, in particular in the green. We have previously described techniques for both temporal and spatial reduction of speckle using a moving holographic diffuser, in our WO2009/087358.

We have now described some alternative techniques for reducing speckle and increasing operational efficiency which are particularly, but not exclusively, applicable to holographic image projection systems.

### SUMMARY OF THE INVENTION

According to the present invention there is therefore provided a holographic image projector, comprising: a laser light source to provide light at a laser wavelength; a first spatial light modulator (SLM) to display a hologram, wherein said first SLM is illuminated by said laser light source; intermediate image optics to provide a first intermediate real image plane at which a real image produced by said hologram displayed on said first SLM is formed; a wavelength-conversion material located at said first intermediate real image plane to convert said laser wavelength to at least a first output wavelength different to said laser wavelength; and second optics to project light from said real image at said output wavelength to provide a displayed image.

In embodiments the wavelength-conversion material re-emits over a range of angles and also over a spread of wavelengths and thus decoheres the laser light, thus providing speckle reduction. In preferred implementations the wavelength conversion material is an optical downconversion material such as a ‘phosphor’. Here we use phosphor to include phosphorescent materials, fluorescent materials and quantum dot materials, though where a phosphorescent material is employed preferably this has a relatively fast decay, for example of the order of a few tens of microseconds. In some preferred implementations the wavelength-conversion material comprises a quantum dot-based material as this provides good efficiency and facilitates achieving a desired output wavelength because the emission from a quantum dot is easily tunable and can operate with small Stokes shifts. In a colour display system this facilitates a selection of red, green and blue wavelengths, for example to match these to the wavelength response of the human eye to achieve maximum perceived brightness. Further the difference between the input and output wavelengths can be small thus enabling, for example, a UV (ultraviolet) pumped wavelength-conversion material to emit in the blue. In embodiments, with either a blue or uv laser, the wavelengths of the displayed image are respectively within 3% of 613 nm, 550 nm and 459 nm.

For materials science related reasons it is difficult to achieve efficient semiconductor laser operation in the green region of the spectrum (and green semiconductor lasers also tend to be expensive). Thus in either a monochrome or a colour display system, In some preferred embodiments the laser wavelength is shorter than around 490 nm, and the output wavelength is longer than the laser wavelength, in embodiments longer than 490 nm. Thus, more generally, in embodiments the laser wavelength is shorter than the upper end of the blue region of the spectrum and the output wavelength is in the green region of the spectrum. This is helpful in improving the overall (‘wall plug’) efficiency of the projector.

In preferred implementations the projector is a (multi) colour projector. Thus preferably the wavelength-conversion material is provided on one or more wavelength-conversion optical elements located at the first intermediate real image plane, the one or more elements defining at least two different spatial regions at least one of which comprises wavelength-conversion material. The one or more wavelength-conversion optical elements may comprise, for example, a light re-emission wheel or, less preferably, a reciprocating optical element. Thus the wheel or other optical element(s) are located in a plane in which the intermediate real image is formed and then moved so that the different regions, or sectors of the wheel, overlap the location of the real image in this plane at different times. In a still further approach, potentially, a layer of phosphor material may be strained by an actuator and thus switched between different output wavelengths to switch between colours.

In preferred embodiments the one or more wavelength-conversion optical elements are, as previously mentioned, implemented by a light re-emission wheel driven by a motor. Where a blue laser is employed, for example having a wavelength less than 490 nm, one of the regions or sectors of the wheel may comprise a transparent or diffusing region. Where a UV laser is employed each of the regions or sectors of the wheel may comprise a wavelength conversion material such as a phosphor, fluorescent or more preferably a quantum dot material. As previously mentioned, quantum dots are favoured with UV illumination because they can operate with a small difference between the exciting and output wavelength and thus facilitate blue re-emission from a UV pump.

In embodiments the light re-emission wheel comprises at least 3 or 4 sectors in which are located at least 2 or 3 wavelength conversion materials each re-emitting at a different wavelength. Where 4 (or more) output ‘colours’ are provided one of the colours may comprise a white light re-emission. In principle many different output colours may be employed to improve the overall colour gamut of the projector. Conversely a light re-emission wheel may advantageously be employed even in a monochrome projector because a stationary phosphor can give rise to a ‘grain’ in the displayed image which is suppressed when the phosphor is moving in the intermediate image plane.

In some preferred implementations the wavelength conversion material is incorporated into an optical cavity formed, for example, by a pair of reflecting layers one to either side of the layer of wavelength conversion material. This helps to control the angle of distribution of light emission from the wavelength conversion material. In preferred embodiments where the laser light impinges upon a first face of the wavelength conversion material and the second (output) optics are located on an opposite side of the wavelength conversion material these reflecting layers are wavelength-selective, more particularly selecting for transmission at the laser wavelength and reflection at the output wavelength on the input side of the phosphor and selecting for reflection of the laser wavelength and transmission at the output wavelength on the output side of the wavelength conversion material. However in other implementations input of laser light to the layer of wavelength conversion material and output of re-emitted light from the layer of wavelength conversion material may be from the same side of the layer of wavelength conversion material.

In some implementations of the colour wheel the sectors of the wheel may be of different angular extent such that the corresponding output wavelengths are displayed for different durations. In this way different output wavelengths may be optimised for the human visual system.

In some preferred implementations the holographic image projector employs two spatial light modulators, a first as previously described displaying the hologram forming the real image on the first intermediate real image plane, and a second spatial light modulator at a second intermediate image plane to intensity modulate the real image. This second SLM may comprise, for example, a digital micro mirror device such as the Texas Instruments DLP™, or a liquid crystal on silicon (LCOS) SLM, or some other SLM technology. Preferably the resolution of the second SLM is greater than that of the first SLM, and the projector includes an image processor to decompose the image data into a lower spatial frequency component used to generate the hologram data, and a higher spatial frequency component for intensity modulating a real image from the hologram. This dual modulation architecture provides a number of advantages including physical compactness and improved image resolution and contrast.

In such an architecture the intensity modulating SLM may be located either before or after the wavelength-conversion intermediate real image plane, although preferably the wavelength-conversion is performed before the intensity modulation. Thus in embodiments the second optics which projects light from the wavelength-conversion real image plane forms a second intermediate image plane at which the second, intensity modulating SLM is located, and this is then followed by output optics to project an image from the second intermediate image plane.

In principle a light re-emission wheel of the type described above may be employed in any laser-based image projection system.

Thus in a related aspect the invention provides a light re-emission wheel for an image projection system, the light-emission wheel having a plurality of sectors, at least one of said sectors comprising a layer of wavelength-conversion material to absorb light at a first wavelength and re-emit light at a different, second wavelength.

In a further related aspect the invention provides a method of reducing speckle in a laser-based image projector, the method comprising: illuminating a spatial light modulator (SLM) with light at laser wavelength from a laser light source; generating a real image at said laser wavelength with light from said SLM in a first intermediate image region within said projector; wavelength-converting said real image at said laser wavelength to an output wavelength different to said laser wavelength using a layer of wavelength-converting material in said first intermediate image region; and projecting light from said real image at said output wavelength to provide a displayed image.

In a corresponding aspect the invention provides an optical system for a laser-based image projector, the optical system comprising: a laser light source; an image generation system to generate a real image using light from said laser light source; a layer of wavelength-converting material at a location of said real image to convert said light from said laser light source to light at different, output wavelength; and second optics to project light from said real image at said output wavelength to provide a displayed image.

### BRIEF DESCRIPTION OF THE DRAWINGS

These and other aspects of the invention will now be further described, by way of example only, with reference to the accompanying figures in which:

FIG. 1 shows, respectively, a vertical cross section view through an example image display device suitable for implementing embodiments of the invention;

FIGS. 2a and 2b show, respectively, a holographic image projection system for use with the device of FIG. 1, and a functional block diagram of the device of FIG. 1;

FIG. 3 shows an embodiment of a display device according to an aspect of the invention;

FIGS. 4a and 4b show, respectively, a uv-pumped quantum dot downconversion plate, and a blue-pumped quantum dot downconversion plate; and

FIG. 5 shows an example material stack for a downconversion plate/wheel.

### DETAILED DESCRIPTION OF PREFERRED EMBODIMENTS

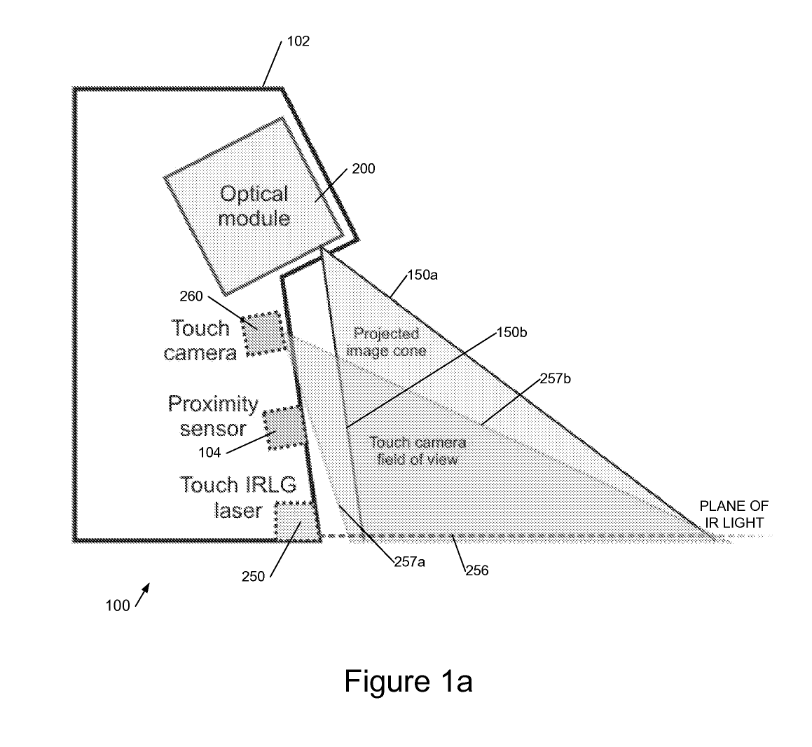

FIG. 1 shows an example holographic image projection device 100, as illustrated a touch sensitive device comprising a holographic image projection module 200 and a touch sensing system 250, 258, 260 in a housing 102. A proximity sensor 104 may be employed to selectively power-up the device on detection of proximity of a user to the device.

A holographic image projector is merely described by way of example; the techniques we describe herein may be employed with any type of image projection system.

As illustrated the holographic image projection module 200 is configured to project downwards and outwards at an acute angle onto a flat display surface such as a tabletop, but additionally or alternatively it may project forwards generally perpendicularly towards a display surface. A holographic image projector is particularly suited to acute angle projection because it can provide a wide throw angle, long depth of field, and substantial distortion correction without significant loss of brightness/efficiency. Boundaries of the light forming the displayed image 150 are indicated by lines 150a, b.

The touch sensing system 250, 260 comprises an infrared laser illumination system (IR line generator) 250 configured to project a sheet of infrared light 256 just above, the surface of the displayed image 150 (although in principle the displayed image could be distant from the touch sensing surface). The laser illumination system 250 may comprise an IR LED or laser, preferably collimated, then expanded in one direction by light sheet optics, which may comprise a negative or cylindrical lens. A CMOS imaging sensor (touch camera) 260 is provided with an ir-pass lens captures light scattered by touching the displayed image 150, with an object such as a finger, through the sheet of infrared light 256. The boundaries of the CMOS imaging sensor field of view are indicated by lines 257, 257a,b. The touch camera 260 provides an output to touch detect signal processing circuitry.

### Example Holographic Image Projection System

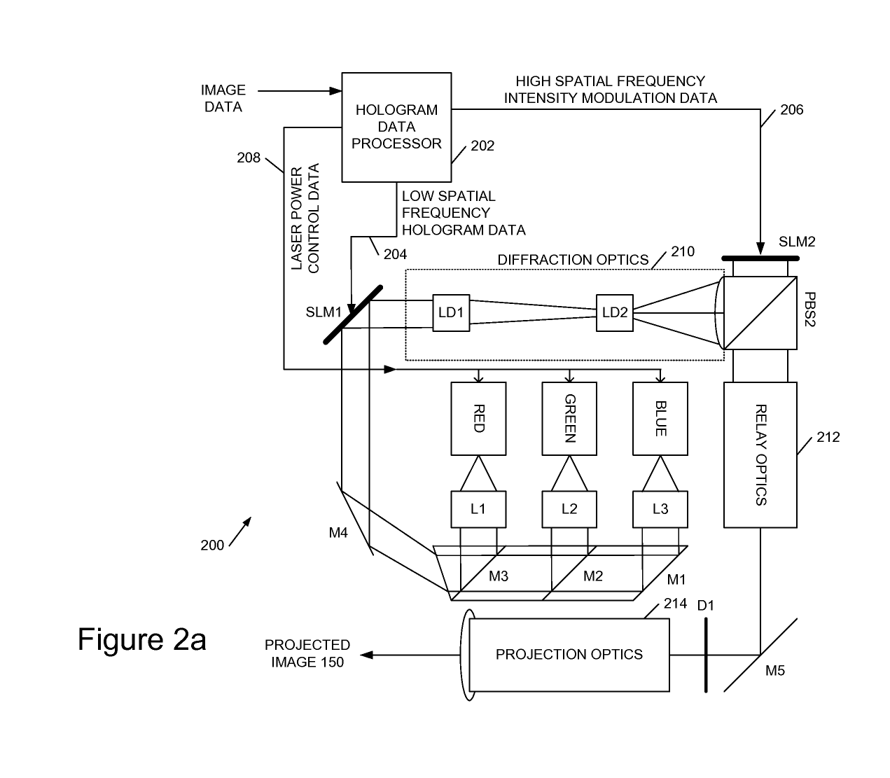

FIG. 2a shows an example holographic image projection system architecture 200 in which the SLM may advantageously be employed. The architecture of FIG. 2 uses dual SLM modulation-low resolution phase modulation and higher resolution amplitude (intensity) modulation. This can provide substantial improvements in image quality, power consumption and physical size. The primary gain of holographic projection over imaging is one of energy efficiency. Thus the low spatial frequencies of an image can be rendered holographically to maintain efficiency and the high-frequency components can be rendered with an intensity-modulating imaging panel, placed in a plane conjugate to the hologram SLM. Effectively, diffracted light from the hologram SLM device (SLM1) is used to illuminate the imaging SLM device (SLM2). Because the high-frequency components contain relatively little energy, the light blocked by the imaging SLM does not significantly decrease the efficiency of the system, unlike in a conventional imaging system. The hologram SLM is preferably be a fast multi-phase device, for example a pixellated MEMS-based piston actuator device.

In FIG. 2a:
SLM1 is a pixellated MEMS-based piston actuator SLM as described above, to display a hologram—for example a 160×160 pixel device with physically small lateral dimensions, e.g <5 mm or <1 mm.
L1, L2 and L3 are collimation lenses (optional, depending upon the laser output) for respective Red, Green and Blue lasers.
M1, M2 and M3 are dichroic mirrors implemented as prism assembly.
M4 is a turning beam mirror.
SLM2 is an imaging SLM and has a resolution at least equal to the target image resolution (e.g. 854×480); it may comprise a LCOS (liquid crystal on silicon) or DMD (Digital Micromirror Device) panel.
Diffraction optics 210 comprises lenses LD1 and LD2, forms an intermediate image plane on the surface of SLM2, and has effective focal length f such that fλ/Δ covers the active area of imaging SLM2, where delta denotes the pixel pitch of SLM1. Thus optics 210 perform a spatial Fourier transform to form a far field illumination pattern in the Fourier plane, which illuminates SLM2.
PBS2 (Polarising Beam Splitter 2) transmits incident light to SLM2, and reflects emergent light into the relay optics 212 (liquid crystal SLM2 rotates the polarisation by 90 degrees). PBS2 preferably has a clear aperture at least as large as the active area of SLM2.
Relay optics 212 relay light to the diffuser D1.
M5 is a beam turning mirror.
D1 is a diffuser to reduce speckle.
Projection optics 214 project the object formed on D1 by the relay optics 212, and preferably provide a large throw angle, for example >90°, for angled projection down onto a table top (the design is simplified by the relatively low entendue from the diffuser).

The different colours are time-multiplexed and the sizes of the replayed images are scaled to match one another, for example by padding a target image for display with zeros (the field size of the displayed image depends upon the pixel size of the SLM not on the number of pixels in the hologram).

A system controller and hologram data processor 202, implemented in software and/or dedicated hardware, inputs image data and provides low spatial frequency hologram data 204 to SLM1 and higher spatial frequency intensity modulation data 206 to SLM2. The controller also provides laser light intensity control data 208 to each of the three lasers. For details of an example hologram calculation procedure reference may be made to WO2010/007404 (hereby incorporated by reference).

The diffuser, D, may be omitted in the embodiments of the invention described later.

Referring now to FIG. 2b, this shows a block diagram of the device 100 of FIG. 1. A system controller 110 is coupled to a touch sensing module 112 from which it receives data defining one or more touched locations on the display area, either in rectangular or in distorted coordinates (in the latter case the system controller may perform keystone distortion compensation). The touch sensing module 112 in embodiments comprises a CMOS sensor driver and touch-detect processing circuitry.

The system controller 110 is also coupled to an input/output module 114 which provides a plurality of external interfaces, in particular for buttons, LEDs, optionally a USB and/or Bluetooth® interface, and a bi-directional wireless communication interface, for example using WiFi®. In embodiments the wireless interface may be employed to download data for display either in the form of images or in the form of hologram data. Non-volatile memory 116, for example Flash RAM is provided to store data for display, including hologram data, as well as distortion compensation data, and touch sensing control data (identifying regions and associated actions/links). Non-volatile memory 116 is coupled to the system controller and to the I/O module 114, as well as to an optional image-to-hologram engine 118 as previously described (also coupled to system controller 110), and to an optical module controller 120 for controlling the optics shown in FIG. 2a. The image-to-hologram engine is optional as the device may receive hologram data for display from an external source. In embodiments the optical module controller 120 receives hologram data for display and drives the hologram display SLM, as well as controlling the laser output powers in order to compensate for brightness variations caused by varying coverage of the display area by the displayed image (for more details see, for example, our WO2008/075096). In embodiments the laser power(s) is (are) controlled dependent on the “coverage” of the image, with coverage defined as the sum of: the image pixel values, preferably raised to a power of gamma (where gamma is typically 2.2). The laser power is inversely dependent on (but not necessarily inversely proportional to) the coverage; in preferred embodiments a lookup table as employed to apply a programmable transfer function between coverage and laser power. The hologram data stored in the non-volatile memory, optionally received by interface 114, therefore in embodiments comprises data defining a power level for one or each of the lasers together with each hologram to be displayed; the hologram data may define a plurality of temporal holographic subframes for a displayed image. Preferred embodiments of the device also include a power management system 122 to control battery charging, monitor power consumption, invoke a sleep mode and the like.

In operation the system controller controls loading of the image/hologram data into the non-volatile memory, where necessary conversion of image data to hologram data, and loading of the hologram data into the optical module and control of the laser intensities. The system controller also performs distortion compensation and controls which image to display when and how the device responds to different “key” presses and includes software to keep track of a state of the device. The controller is also configured to transition between states (images) on detection of touch events with coordinates in the correct range, a detected touch triggering an event such as a display of another image and hence a transition to another state. The system controller 110 also, in embodiments, manages price updates of displayed menu items, and optionally payment, and the like.

Details of the image processing can be found in our earlier patent application WO2010/007404. In embodiments of the system low and high spatial frequency components of the image data are extracted to provide the first (low resolution) and second (high resolution) image data. A hologram is generated from the low resolution image data such that when the hologram is displayed on the hologram SLM it reproduces a version of the low resolution image data comprising the low spatial frequencies of the image. In embodiments displaying the hologram comprises displaying multiple, temporal subframes which noise-average to give a version of the low spatial frequency component of the image data, thus providing the intermediate real image. In general the intermediate real image will not be a precisely accurate reproduction of the low spatial frequency portion or component of the image data since it will have associated noise. Thus preferred embodiments of the method calculate the expected intermediate real image (including the noise) and then determine the high spatial frequency component of the image data which is to be displayed on the intensity modulating SLM as that (high spatial frequency) portion or component of the image data which is left over from the intermediate real image. The intensity modulation comprises, in effect, a multiplication of the intermediate real image by the pattern on the intensity modulating SLM (the second image data). Thus to determine the high spatial frequency components left over from the holographic display of the lower spatial frequency components, in embodiments the image data is divided by the intermediate real image which is calculated to be formed by the displayed hologram. Since an intensity modulating SLM only removes light from the intermediate real image (by blocking light), in some preferred embodiments the image data from which the hologram displayed on the hologram SLM is generated comprises a reduced resolution of the image data in which each reduced resolution pixel has a value dependent on the image pixels from which it is derived, preferably (but not necessarily) a peak value of the image pixel values from which it is derived.

### Wavelength Conversion Systems

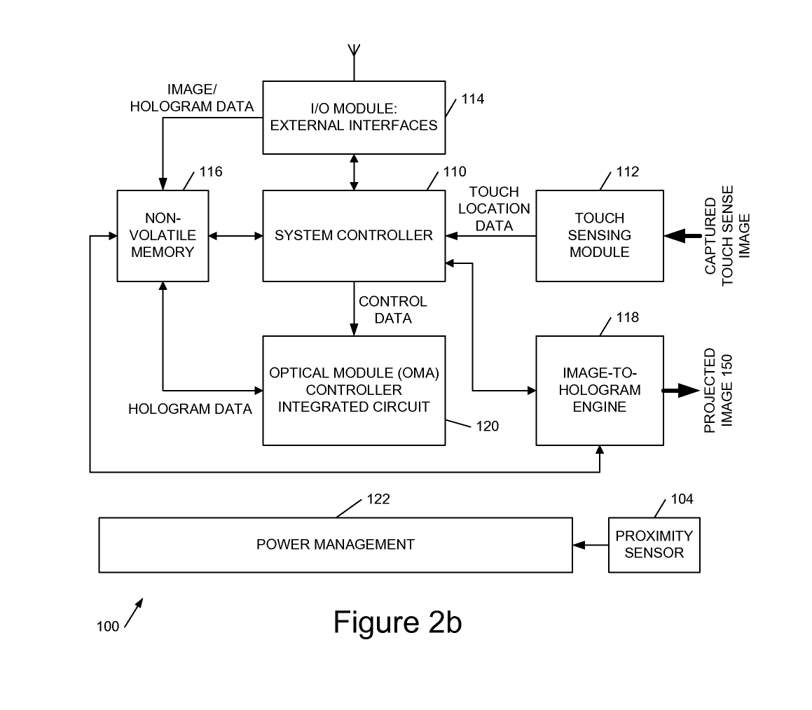

Referring now to FIG. 3, this shows an embodiment of a holographic image projector 300 according to the invention. The system comprises a pump laser 302 followed by collimation optics 304 which provide a collimated beam to a first, defractive spatial light modulator 306 corresponding to SLM1 in FIG. 2a. This is followed by Fourier optics 307 which reproduce an image generated by a hologram on diffractive SLM 306 at a Fourier or real image plane 308. The hologram displayed on SLM 306 is a hologram of a 2D image for display and illumination of the hologram with collimated light from laser 302 replays the real image encoded by the hologram at Fourier plane 308.

A downconversion plate, as illustrated a light re-emission wheel 350 is located in real image plane 308 and rotated by a motor (not shown) about axis 352. Details of downconversion plate 350 are described later but, broadly speaking, this plate has three or more sectors to provide at least a red, green and blue colour output from the intermediate real image plane as the plate rotates, by downconversion of the light from pump laser 302.

These time multiplexed red, green and blue images provide an input of relay optics 310 which provide a second intermediate real image plane at which a second spatial light modulator (imaging panel) 312 is located, corresponding to SLM 2 in FIG. 2a. This second imaging panel may comprise for example, an LCOS or DLP™ spatial light modulator. The imaging panel 312 intensity modulates the real image at this second intermediate image plane and this final real image is then projected onto a projection surface 316 by projection optics 314.

In FIG. 3 dotted lines indicate the pump laser light, for example at less than 480 nm, and the dashed lines indicate downconverted light, typically in the range 440 nm-660 nm.

In one embodiment the pump laser is a blue laser and the downconversion plate has three sectors, two to downconvert the blue light to red light and green light and a third to allow the blue light through to the projection surface. In this embodiment the third sector may be clear or, more preferably, may comprise a diffuser. Alternatively pump laser 302 may be a UV laser and downconversion plate 350 may have three sectors, one to re-radiate at each of a red, green and blue wavelength. Use of a UV laser is currently advantageous because a low cost ‘BluRay’™ type laser may be employed. Fluorescent/phosphorescent materials tend to have a minimum wavelength gap between the pump and output wavelength which can make it difficult to achieve a good blue and thus where a UV laser is employed preferably the wavelength conversion material comprises quantum dots which have no such limitation.

By comparison with the arrangement of FIG. 2a, that of FIG. 3 provides a number of advantages: a single laser is employed rather than three lasers, in particular avoiding the use of a relatively low efficiency green laser. This also removes the need for the dichroic mirrors M1-M3 of FIG. 2a. Furthermore the optics can be designed for use with a single wavelength, which allows the use of simpler/cheaper lenses because there is no need to correct for chromatic aberration, and the use of cheaper single wavelength rather than broadband coatings. More particularly, however, the arrangement of FIG. 3 substantially reduces speckle, partly because wavelength conversion materials naturally emit over a relatively large solid angle, providing angular diversity, and partly because the downconversion process naturally spreads the narrow laser line into a broader bandwidth emission, for example a bandwidth in the range 20-50 nm, thus decohering the light and reducing the speckle.

The rotation of the downconversion plate 350 is synchronised with the display of the hologram on SLM 306 and the intensity modulating image on SLM 312. This may be achieved either by employing a stepper motor drive for downconversion plate 350 or a free running motor in combination with an optical position detector such as a cutout in plate 350 in combination with a photodiode sensor providing a signal to the hologram data processor (processor 202 in FIG. 2a). Optionally there may be a feedback loop between the position sensing and stepper motor drive.

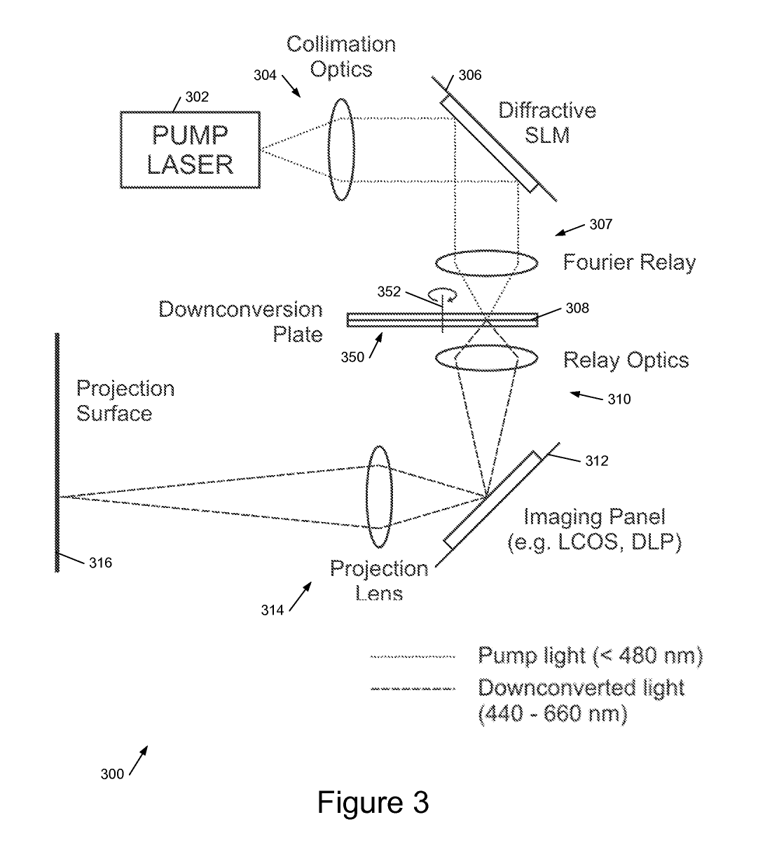

FIG. 4a shows a first embodiment of a downconversion plate 350, for use with a UV pump laser. This has three sectors 354a, 356a, 358a each comprising quantum dots to re-emit at, respectively, 613 nm, 550 nm and 459 nm. These wavelengths are selected to optimise the apparent brightness of the respective red, green and blue colours with respect to the human visual system. In

[symbol]

FIG. 4b shows a corresponding downconversion plate 350b for use with a blue pump laser 302. This plate has corresponding sectors 354b, 356b, but the blue sector 358b comprises a diffuser. The skilled person will appreciate that, optionally, more colours may be employed in the downconversion plate including, for example, a ‘white’ colour plane.

As illustrated in FIG. 4 the sectors have equal angular extent but in other embodiments the sectors may have different angular extents to adjust the relative duty cycle of the three time-multiplexed colour planes to compensate for the different response of the human eye to different colours. Thus in particular a longer duty cycle may be provided for the red to equalise the apparent brightness of this colour. Additionally or alternatively the optical output power of pump laser 302 may be modulated up/down according to the selected sector of the downconversion plate for a similar reason. Broadly speaking the aim is that when the system receives image data defining white, for example maximum red, green and blue values, a good white is displayed on surface 316.

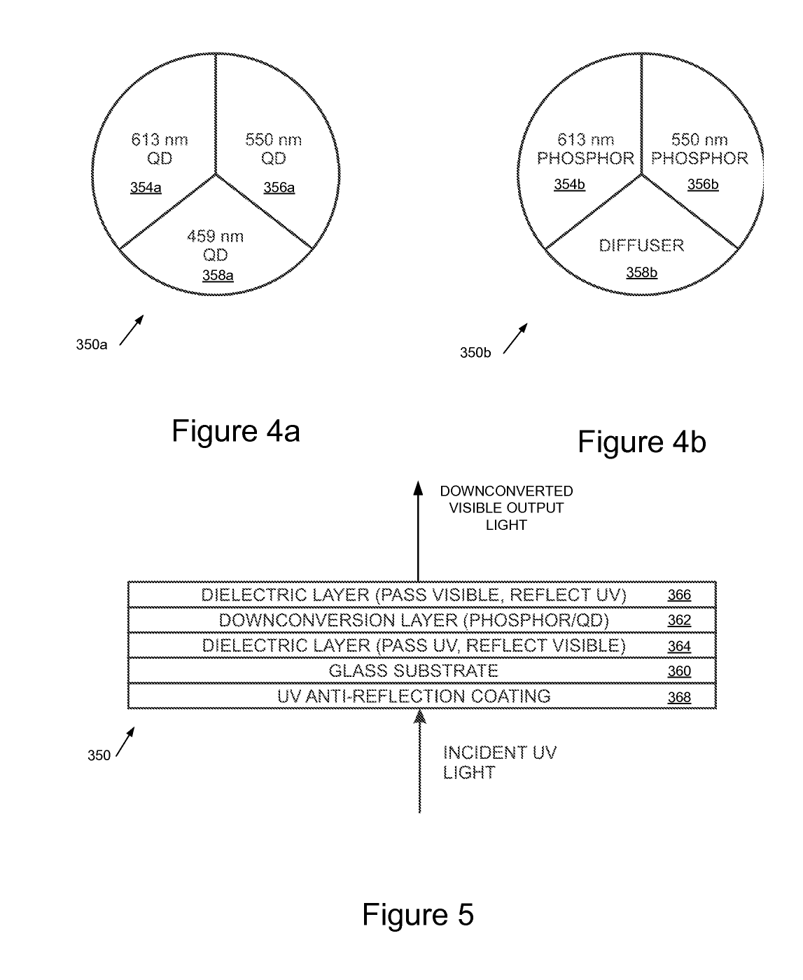

FIG. 5 shows a vertical cross-section through downconversion plate 350 (not to scale) illustrating an example layer structure of this plate. As illustrated UV light is incident through the bottom of the plate, that is through glass substrate 360 via a (UV) anti-reflection coating 368, but in other arrangements the pump laser may be incident from the top of the downconversion plate (FIG. 3 illustrates a bottom-illuminated plate though the drawing is inverted in FIG. 5).

The plate 350 is provided with a downconversion layer 362 which is preferably enclosed in an optical cavity formed by a pair of reflecting layers 364, 366 one to either side of phosphor layer 362. The reflecting layers 364, 366 may comprise a dielectric stack, for example a stack of silicon dioxide and/or silicon nitride and/or magnesium fluoride. In the configuration shown preferably layer 364 is arranged to pass the pump laser wavelength and reflect visible light from the phosphor, and layer 366 is arranged to pass visible light and reflect the pump laser light by forming a microcavity. This helps to achieve efficient downconversion and also efficient transfer of the downconverted light towards the projection surface 316. In embodiments the dielectric stacks 364, 366 may be tuned to restrict the range of output angles of the downconverted visible light and/or the range of acceptance angles of the pump laser light. The skilled person will appreciate that the optical transmission/reflectance of a dielectric stack has an angular dependence, and once the wavelength to be transmitted and reflected and the angular dependence has been chosen, standard techniques may be employed to design and fabricate the stack and/or an external optical component manufacturer may be employed.

In embodiments the thickness of layer 362 is at least of the order of at least the pump laser wavelength. More particularly, where there is a reflection at the ‘back’ surface 366 the laser light makes two passes through the downconversion layer and thus twice the thickness of this layer should be at least as long as the 1/e absorption depth of the material. Some quantum dots can be relatively poor absorbers, and in this case the thickness of layer 362 may be up to a few 10s of μms. The thicknesses of layers 364, 366 are typically 1 to a few μms (of order n λ). The quantum efficiency of the downconversion process can be high, for example 85-90%, apart from the inherent quantum (Stokes) loss resulting from converting, for example a photon in the UV to a photon in the red. Since photon energy is proportional to frequency, this loss is proportional to one minus the ratio of wavelengths and may be up to 25% for the worst case example just quoted.

In one embodiment layer 366 has a thickness of order 1 μm and comprises multiple 100 nm layers; 362 has a thickness in the range 0.5-20 μms (dependent upon the materials), layer 364 has thickness of order 1 μm and comprises multiple 100 nm layers, plus substrate 360 has a thickness in the range 0.5-5 mm, and coating 362 has a thickness in the range 100 nm-1 μm.

Although we have described a preferred implementation of the system, many variations are possible. For example the downconversion may be after the imaging panel 312 rather than before. However this is less preferable because typically an LCOS or DLP spatial light modulator is optimised for visible rather then UV illumination. In another variant three pump lasers are employed illuminating SLM 306 at three different angles, and the light from this is then provided to three different spatial regions on a stationary downconversion plate and the light from the 2, 3 (or more) wavelength conversion materials on this plate is then combined prior to modulation by imaging panel 312 (though alternatively multiple imaging panels 312 could be provided and the light combined afterwards). The different colours of downconverted light may be combined, for example, using a dichroic X-cube (a colour combiner with internal diagonal faces giving the appearance of an ‘X’). In a variant of this approach three separate diffractive SLMs may be employed with three separate downconversion plates, one for each wavelength conversion material. In a still further variant rather than three pump lasers being employed, a single pump laser beam may be split into three beams, preferably after the diffractive SLM and then provided to three phosphors and recombined for intensity modulation (or three separate intensity modulating SLMs employed). In all the approaches the skilled person will appreciate that the pump laser may be either blue or UV, and where the pump laser is blue one of the wavelength conversion materials may be replaced by a diffuser. Similarly the skilled person will appreciate that where there is a reference to three wavelength conversion materials, more may be employed.

In a still further, less preferable, variant a similar approach to that of FIG. 2a may be adopted but the green laser replaced by a UV laser and the UV light converted to green at some point in the optical path by being split off, downconverted, and recombined. Although preferred embodiments provide a (multi) colour image projector, the technique nonetheless offers advantages of improved efficiency and reduced speckle in a monochrome system in particular where the monochrome colour is green.

Although the techniques we have described are particularly advantageous in a holographic light projector, they may advantageously be employed for speckle reduction and/or improved efficiency in other, non-holographic laser-based image projectors.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A holographic image projector, comprising:
a laser light source to provide light at a laser wavelength;
a first spatial light modulator (SLM) to display a hologram, wherein said first SLM is illuminated by said laser light source;
intermediate image optics to provide a first intermediate real image plane at which a real image produced by said hologram displayed on said first SLM is formed;
a wavelength-conversion material located at said first intermediate real image plane to convert said laser wavelength to at least a first output wavelength different to said laser wavelength; and
second optics to project light from said real image at said output wavelength to provide a displayed image.

2. A holographic image projector as claimed in claim 1 wherein said wavelength-conversion material comprises an optical downconversion material, and wherein said output wavelength is longer than said laser wavelength.

3. A holographic image projector as claimed in claim 2 wherein said laser wavelength is shorter than 490 nm, and wherein said output wavelength is longer than said laser wavelength.

4. A holographic image projector as claimed in claim 1 wherein said wavelength-conversion material comprises a quantum-dot based optical downconversion material.

5. A holographic image projector as claimed in claim 1 having a plurality of said output wavelengths to provide a multicolour said displayed image, and further comprising one or more wavelength conversion optical elements located at said first intermediate real image plane, wherein said one or more wavelength conversion optical elements define at least two different spatial regions in said intermediate image plane, at least a first said region comprising said wavelength conversion material.

6. A holographic image projector as claimed in claim 5 wherein said laser wavelength comprises a visible laser wavelength less than 490 nm, and wherein a second of said regions comprises a transparent or diffusing region.

7. A holographic image projector as claimed in claim 5 wherein a second of said regions comprises a second wavelength-conversion material to convert said laser wavelength to a second said output wavelength different to both said laser wavelength and said first output wavelength.

8. A holographic image projector as claimed in claim 5, comprising at least four said spatial regions and at least three said wavelength conversion materials each in a different responsive spatial regions to provide a said multicolour displayed image comprising at least four different colours.

9. A holographic image projector as claimed in claim 5 wherein said different spatial regions have different spatial extents such that different said output wavelengths of said multicolour displayed image are displayed for different respective durations.

10. A holographic image projector as claimed in claim 5 wherein a said wavelength conversion optical element comprises an optical cavity, and wherein said wavelength-conversion material is located within said optical cavity.

11. A holographic image projector as claimed in claim 10 wherein said optical cavity is configured to limit an angular distribution of light at said output wavelength emitted from said wavelength-conversion material.

12. A holographic image projector as claimed in claim 10 wherein said optical cavity comprises one or both of:
i) a first wavelength-selective layer on a side of said cavity on which said laser light is incident, wherein said first wavelength-selective layer is configured to pass said laser wavelength preferentially to said output wavelength and to reflect said output wavelength preferentially to said laser wavelength; and
ii) a second wavelength-selective layer on a side of said cavity towards said second optics, wherein said second wavelength-selective layer is configured to pass said output wavelength preferentially to said laser wavelength and to reflect said laser wavelength preferentially to said output wavelength.

13. A holographic image projector as claimed in claim 1 comprising a light re-emission wheel located at said first intermediate real image plane to absorb light at said laser wavelength and re-emit said absorbed light at at least said first output wavelength.

14. A holographic image projector as claimed in claim 13 wherein said light re-emission wheel has sectors defining at least two different spatial regions, at least a first said region comprising said wavelength conversion material; and a motor to drive rotation of said light re-emission wheel.

15. A holographic image projector as claimed in claim 14 wherein said different spatial regions have different spatial extents such that different said output wavelengths of said multicolour displayed image are displayed for different respective durations.

16. A holographic image projector as claimed in claim 13 wherein a said re-emission wheel comprises an optical cavity, and wherein said wavelength-conversion material is located within said optical cavity.

17. A holographic image projector as claimed in claim 16 wherein said optical cavity is configured to limit an angular distribution of light at said output wavelength emitted from said wavelength-conversion material.

18. A holographic image projector as claimed in claim 16 wherein said optical cavity comprises one or both of:
i) a first wavelength-selective layer on a side of said cavity on which said laser light is incident, wherein said first wavelength-selective layer is configured to pass said laser wavelength preferentially to said output wavelength and to reflect said output wavelength preferentially to said laser wavelength; and
ii) a second wavelength-selective layer on a side of said cavity towards said second optics, wherein said second wavelength-selective layer is configured to pass said output wavelength preferentially to said laser wavelength and to reflect said laser wavelength preferentially to said output wavelength.

19. A holographic image projector as claimed in claim 1 wherein said second optics comprises a second SLM at a second intermediate image plane of said projector to intensity modulate said real image; and output optics to project an image of said intensity modulated real image.

20. A holographic image projector as claimed in claim 19 wherein a resolution of said second SLM is greater than a resolution of said first SLM; and further comprising a processor,
to decompose image data for display into first image data representing a first spatial frequency component of said image data and second image data representing a second spatial frequency component of said image data, wherein said second spatial frequency is higher than said first spatial frequency, and
to generate hologram data for said hologram from said first image data and to output said second image data to second SLM, such that said displayed image has a greater resolution than said real image.

21. A light re-emission wheel for an image projection system, the light re-emission wheel having a plurality of sectors, at least one of said sectors comprising a layer of wavelength-conversion material to absorb light at a first wavelength and re-emit light at a different, second wavelength.

22. A light re-emission wheel as claimed in claim 21 wherein said wavelength-conversion material comprises a quantum dot based optical downconversion material.

23. A light re-emission wheel as claimed in claim 21 wherein said wavelength-emission material is located within an optical cavity.

24. A light re-emission wheel as claimed in claim 21 comprising a plurality of different said wavelength-conversion materials within different respective said sectors, said plurality of different wavelength-conversion materials re-emitting light at a plurality of different respective said second wavelengths.

25. A method of reducing speckle in a laser-based image projector, the method comprising:
illuminating a spatial light modulator (SLM) with light at laser wavelength from a laser light source;
generating a real image at said laser wavelength with light from said SLM in a first intermediate image region within said projector;
wavelength-converting said real image at said laser wavelength to an output wavelength different to said laser wavelength using a layer of wavelength-converting material in said first intermediate image region; and
projecting light from said real image at said output wavelength to provide a displayed image.

26. A method of reducing speckle as claimed in claim 25 wherein said laser wavelength is shorter than 490 nm, and wherein said output wavelength is longer than said laser wavelength.

27. A method of reducing speckle as claimed in claim 25 wherein said wavelength converting uses quantum dots.

28. A method of reducing speckle as claimed in claim 25 comprising providing a multicoloured said displayed image using an optical element having at least two different spatial regions, at least one of said spatial regions comprising said layer of wavelength-converting material; and wherein said wavelength-converting comprises moving said optical element such that different said spatial regions are at a location of said real image within said first intermediate image region at different times.

29. A method of reducing speckle as claimed in claim 25 comprising displaying a hologram on said SLM to generate said real image, and further comprising intensity modulating said real image using a second SLM to provide said displayed image.

30. An optical system for a laser-based image projector, the optical system comprising:
a laser light source;
an image generation system to generate a real image using light from said laser light source;
a layer of wavelength-converting material at a location of said real image to convert said light from said laser light source to light at different, output wavelength; and
second optics to project light from said real image at said output wavelength to provide a displayed image.
